(19) United States
(12) Patent Application Publication
(10) Pub. No.: US 2006/0086836 A1
(43) Pub. Date: Apr. 27, 2006

(54) Rubber and plastic bonding

(76) Inventor: John D. Osborn, Port Roliver, TX (US)

Correspondence Address: Polly D. Heseman, P.A., 267 Corsair Ave., Lauderdale By The Sea, FL, 33308, US

(21) Appl. No.: 11/143,058

(22) Filed: Jun. 2, 2005

Related U.S. Application Data
(62) Division of application No. 10/405,164, filed on Apr. 2, 2003, now abandoned.
Application No. 10/405,164 is a continuation of application No. 09/773,697, filed on Jan. 31, 2001, now abandoned.
Application No. 09/773,697 is a continuation of application No. 08/934,624, filed on Sep. 19, 1997, now abandoned.
Application No. 08/934,624 is a continuation-in-part of application No. 08/677,697, filed on Jul. 10, 1996, now abandoned.
Application No. 08/677,697 is a continuation of application No. 08/391,386, filed on Feb. 21, 1995, now Pat. No. 5,604,277.
Application No. 08/391,386 is a continuation of application No. 07/886,338, filed on May 20, 1992, now abandoned.

(51) Int. Cl. B02C 23/06

(52) U.S. Cl. 241/16

(57) ABSTRACT

The use of a dry liquid concentrate mixture is disclosed comprising crumb rubber particles and tall oil, tall oil derivatives or other fatty acids, which may be enhanced by other components, such as modifiers, for use to enhance the properties of parent materials, such as thermoplastic compounding and coatings and elastomers and recycles and asphalt and epoxies and aliphatic urethane using preexisting equipment and preblending processes for the additives and modifiers.

### CROSS REFERENCE TO RELATED APPLICATIONS

This application is a continuation-in-part of U.S. application Ser. No. 08/934,624, which is a continuation-in-part of U.S. patent application Ser. No. 08/677,697, filed Jul. 10, 1996, entitled Improved Pavement Material, which is a continuation-in-part of U.S. Pat. No. 5,604,277, issued Feb. 18, 1997, entitled Rubber and Plastic Bonding, which is a continuation of U.S. Pat. No. 5,488,080, issued Jan. 30, 1996, entitled Rubber and Plastic Bonding, which is a continuation of U.S. Patent Application 886,338, filed May 20, 1992, entitled Rubber and Plastic Bonding now abandoned.

### BACKGROUND OF THE INVENTION

1. Field of the Invention

The present invention relates generally to the utilization of scrap tires, and more particularly to the bonding of rubber and plastic material.

2. Background of the Art

Each year there are an estimated 250,000,000 scrap tires discarded throughout the United States. Unwanted scrap tire piles, scattered throughout the country, have been estimated as high as 3 billion units. The poor biodegradability of scrap tires, their tendency to trap gases and rise to the surface in landfills, the serious fire hazard scrap tire piles represent, and the breeding environment that unwanted scrap tire piles offer to disease carrying pests, such as rodents and mosquitos, has caused them to be classified as a serious environmental nuisance.

Attempts to reuse the materials composing scrap tires have had very limited economic success. Many of these involve destructive distillation. The approaches to reuse, burn, or distill scrap tires appear not to have been commercially successful and had little effect on reducing either the flow or accumulation of scrap tire carcasses.

Truck tire carcasses with acceptable sidewall structure are recapped. The original tread stock of a used truck tire is removed by buffing. The resulting tire buffings, generated from the removal of the original tread stock, have been the primary feedstock material for the United States tire generated crumb rubber industry. This utilization, however, is limited in its scope and does not address the problem presented by scrap passenger or truck tire carcasses no longer suitable to be recapped.

Other methods of using scrap tire carcasses have included burning tire chips for BTU value and low and high vacuum pyrolysis to recover oil, carbon black, steel and fiber.

Several methods have been employed to enhance the value of scrap tire derived crumb rubber in vulcanized curing procedures. These methods are: polymeric coatings to enhance re-manufacture in rubber goods, addition of various quantities of tall oil derived fatty acids to adhere rubber particles into a useful mass, sulfur additions to act as a vulcanizing agent, and various complete devulcanization processes. Tire generated crumb rubber is also used in minimal percentages with virgin rubber as a filler and mixed with hot asphalt as a modifier.

Plastics is a multibillion-dollar industry which produces synthetic materials and products, many of which were never dreamed of only a few years ago. Today, civilization requires synthetic materials (artificial resins produced by chemical reactions of organic substances). Many products made of plastic produced materials are produced at less cost than was possible with natural materials.

Plastics, unlike glass or aluminum, are not easily recycled back into useful products, such as those which they were generated. Plastics, being a specifically engineered, rather than a generic material, are sorted prior to recycling. Plastics are seldom remanufactured back into the product or part which generated them. Often, recycled plastics are more expensive than new polymers. Examples of plastics which are recycled include: (1) HDPE and LDPE into boards, bins, and trash cans and (2) PET into carpet fiber. The markets for recycled plastics have been slow to develop and do not appear to be able to keep pace with the generation of new plastic materials. Once plastics are molded or spun, they lose some of the characteristics or properties of the virgin material. This creates a much bigger problem than scrap tires because the United States generates over 12 billion tons of scrap plastics per year, most of which is destined for deposit in landfills.

It would be desirable to develop cost feasible, raw material products generated from a whole scrap tire and plastic feed stocks, involving the crumb rubber produced from both the sidewall and tread materials. Because of the vast quantity of accumulated scrap tires and scrap plastics, it would be beneficial to broaden the market applications by forming new raw materials containing the combined properties of both crumb rubber and plastic.

The prior art regarding the creation of rubber thermoplastic compounds involves utilization of substantial mechanical energy. Thermoplastic, often polypropylene, is combined with virgin rubber in a masticating mixer such as a banbury. Subsequent to initial mastication, the rubber plastic mixture is processed through a high intensity mix cycle to evenly disperse the rubber with the plastic. The final step to yield a usable compound is processing with a thermal extruder. The resultant thermoplastic elastomer or thermoplastic olefin compound(s) contain 1-3 micron 90% plus cured rubber dispersed with the plastic. Final processing, such as molding with a thermal extruder, typically results in a slower cycle than the plastic alone.

Typical to the prior art of using vulcanizing crumb rubber with plastic is the addition to an adhesive polymer often ethylene vinyl acetate (EVA) which forms an adhesive bond between the crumb rubber and common cohesive thermoplastics such as polyethylene and polypropylene. These mixtures tend to require excessive pressure to function in standard injection mold machinery resulting in limited application.

It is an object of this invention to substantially increase the economic, functional and environmental benefits beyond previous methods in order to utilize scrap tires as a resource.

It is well-known in the prior art to use tall oil with ground rubber waste for reuse as rubber. See “Ground Rubber Waste—A Supplementary Raw Material for the Rubber Industry” issued by Kahl & Co.; U.S. Pat. No. 4,481,335, issued Nov. 6, 1984 to Stark, Jr. entitled “Rubber Composition and Method”; U.S. Pat. No. 3,873,482, issued Mar. 25, 1975 to Severson et al, entitled “Pyrolyzed Tall Oil Products as Synthetic Rubber Tackifiers”; U.S. Pat. No. 4,895,911, issued Jan. 23, 1990 to Mowdood et al, entitled “Tall Oil Fatty Acid Mixture in Rubber”; U.S. Pat. No. 4,792,589, issued Dec. 20, 1988 to Colvin et al, entitled “Rubber Vulcanization Agents of Sulfur and Olefin”; and U.S. Pat. No. 4,224,841, issued Jan. 13, 1981 to Frankland, entitled “Method for Recycling Rubber and Recycled Rubber Product”. Generally for the area of ground polymer elastomer operation, see U.S. Pat. No. 4,771,110, issued Sep. 13, 1988 to Bouman et al, entitled “Polymeric Materials Having Controlled Physical Properties and Purposes for Obtaining These”; and for rubber discussions see U.S. Pat. No. 3,544,492, issued Dec. 1, 1970, to Taylor et al, entitled “Sulfur Containing Curing Agents”; and “Organic Chemistry” by Fieser and Fieser printed 1944 by D.C. Heath & Co. Boston, pages 346 and 347.

### SUMMARY OF THE INVENTION

The present invention is a dry liquid concentrate mixture in combination with organic and other components which dry liquid concentrate includes the base combination of: the major constituent crumb rubber, generated, for example, from processing the tread or sidewall of scrap tires, and a minor constituent of tall oil, its derivatives and other fatty acids. This combination forms the dry liquid concentrate mixture capable of acting as an impact modifier, homogenizing ingredient, extender, and viscoelastic modifier in a variety of non vulcanized cure systems for plastics. The dry liquid concentrate mixture can also function as a carrying agent for additional plasticizing or compatibilizing chemicals to focus on specific applications.

The preferred dry liquid concentrate mixture is a homogeneous blend of cured and shaped rubber particles that contain minimum moisture content and a liquid blend of tall oil, tall oil derivatives and other fatty acids. These liquid blends plasticize, swell, and soften the rubber particles, reduce friction, and aid bonds between the rubber particle, thermoplastics, and thermoplastic elastomers, and is useful in thermoplastic reclamation.

The dry liquid concentrate mixture imparts elastomeric characteristics into the parent materials with which it is combined. Acting as an impact modifier, it helps to improve the modulus, elongation and changes the viscoelastic characteristics and helps to blend out crystalline spots in various high molecular weight polymers. Acting as a processing aid in polyethelylene and other polymeric reclamations, it homogenizes varieties of various molecular weight polymers together, imparting beneficial properties that even virgin polymers do not possess.

The dry liquid concentrate, used in combination with a mineral hydrocarbon to modify asphalt, produced the result of a lower required asphalt binder content in computer generated pavement design. This result was counter to the known art in that the asphalt binder's viscosity was increased from 500 cpi to 8,000 cpi, however the required asphalt binder dropped from 5.0% to 4.4% in the pavement mix design. Typical to the prior art, modified asphalt binder, being thicker, requires an increase in percent of content to spread evenly through the pavement mixture. The unexpected result was credited to the reduced coefficient of friction in the dry liquid concentrate.

This invention surpasses the prior art in that the dry liquid concentrate has a reduced coefficient of friction while being employed in standard thermoplastic production machinery, allowing the unexpected result of the rubber functioning as a processing aid, dispersing agent, a modifier, as well as speeding up the typical production cycle of the plastic alone. This invention surpasses the prior art in energy savings and functionality over other methods to incorporate crumb rubber and plastic into a useful thermoplastic raw materials and for coloring and adding other ingredients that are to be uniformly dispersed in the mixture.

The dry liquid concentrate also adds the following captured and dispersed in the tire rubber: (1) carbon black, (2) ultra violet stabilizers, (3) heat stabilizers, (4) impact modifiers, and (5) antioxidants.

### DESCRIPTION OF THE PREFERRED EMBODIMENTS

Post vulcanized crosslinked elastomer(s) which has been further processed by ambient or cryogenic grinding into cured rubber granules or power form a primary component of the dry liquid concentrate mixture used in the present invention mixture. The cured rubber particles used are of natural or synthetic rubber, or a combination thereof, which has been substantially vulcanized or cured, as in the manufacture of automobile or truck tires. Scrap tires, including but not limited to, automobile and truck tires constitute a primary source of available, useful cured rubber particles. With respect to scrap tires as a source of cured rubber particles, the mixture is equally effective with crumb rubber generated either from the sidewall or tread of scrap automobile or truck tire carcasses. Common rubbers useful to the invention include, but are not limited to: NR, SBR, isoprene, EPDM, neoprene, nitrile, butyl and ethylene-propylenediene rubbers. There is no need to separate the rubbers by polymer content. It is desirable for the crumb rubber to be substantially dry with a moisture content of less than 1%. The crumb rubber particles should be substantially free of contaminants such as steel and fiber. The rubber particle mesh sizes in the preferred embodiments range in general from about 10 mesh to 400 mesh with a preferable range of 40 mesh to 400 mesh and further preferably mesh ranges 80-400 mesh, however the particles are formed. For how the particles are formed, and generally for mixing with other basic components of the dry-liquid concentrate mixture, see U.S. Pat. No. 5,604,277, incorporated herein by reference.

A second component of the preferred embodiments which substantially increases the usefulness of the mixture by accelerating the heat driven interaction between the vulcanized rubber crumb and the thermoplastics is one taken from the group of tall oil, tall oil heads, residues of tall oil production, tall oil pitches and other fatty acids (“Tall Oil Agents”). Tall Oil Agents may preferably be any of Unitol DP-5 available from Union Camp Corporation, NEO-SPANGOL T20 available from Kahl & Co. and other formulations comprising tall oil, tall oil heads, tall oil pitches, residues of tall oil production and other fatty acids within the following ranges of characteristics:

| | |
|---|---|
| Viscocity, (centistokes at 99° C.) | 10-1,000 |
| Acid Number (Total) | 15-330 |
| Saponification Number | 10-350 |
| Fatty Acids % | 5%-100% |
| Rosin Acids % | 0%-70% |
| Unsaponifiables % | 5%-80% |

Tall Oil Agents, when used in the preferred embodiments, are combined with crumb rubber, forming a Dry Liquid Concentrate, “DLC”. This may easily be performed in a ribbon blender or similar mixing device, preferably a dispersion mixing system. It is important the DLC be substantially dry or steam will be generated in the plastic molding equipment affecting part integrity.

The Dry Liquid Concentrate, “DLC”, is comprised of a uniform mixture of vulcanized crumb rubber and the above described Tall Oil Agents. The DLC's primary component is the post vulcanized rubber crumb which comprises, by weight percentage, from 60% to 95%, and preferably from 70% to 90% of the DLC. Mixing of the rubber particles with the Tall Oil Agents is best accomplished by a dispersion mixing system such as a ribbon blender; mastication is not required, at ambient temperatures above 60° F. due to the flow ability of the tall oil components of the mix. Blending of the vulcanized crumb rubber with the Tall Oil Agents can be done at ambient temperature, however pre-warming the rubber particles to approximately 180° F. and then introducing the chemical agents, such as the Tall Oil Agent formulations at 200° F. provides a faster mixing cycle. Upon discharge from the mixer, the DLC is a free flowing or pulverlent granular solid or powder.

As set out in U.S. Pat. No. 5,488,080, Column 3, Lines 55 through Column 4, Line 19 and U.S. Pat. No. 5,604,277, Column 3, Lines 53 through Column 4, Line 16, rubber particle shape and size are important elements of the rubber particles for use with the dry liquid concentrate mixture. The variety of processing systems designed to recover the available rubber particles from scrap tire carcasses include: granulation, stone grinding, cutting, sonic impacting, cracking, and cryogenic fragmentation. These various processing systems yield particles of different classes of size and shape. Granulation and cryogenic fragmentation yield particles with similar height, width, and depth dimensions, as well as a relatively smooth surface. Stone grinding, sonic impacting and cracking yield particles with greater surface are per mesh size and rough surface more conductive to the formation of mechanical bonds. Rubber particles, regardless of the method of production fall into four basic shape categories:

| | |
|---|---|
| CRYOGENIC MATERIALS | Smooth Surface |
| ABRADED MATERIALS | Rough Surface |
| TORN MATERIALS | Rough Surface |
| CUT MATERIALS | Smooth Surface but not as smooth as |
| | Cryogenic Materials |

The cured rubber particles maintain their memory of shape in all of the applications of the dry liquid concentrate mixture. Functional mesh size is determined by application. Rough surfaces, such as flake and oblong surfaces, of rubber particles will obtain greater mechanical bonds and add flexibility to materials in which they are used. Smooth surfaces, such as cubic rubber particles, are effective in adding the greatest resistance to abrasion and range of temperature to materials in which they are used.

The amount of crumb rubber employed in the DLC is from 60%-95% by weight. The remainder is taken from the class of tall oil, tall oil heads, residues of tall oil production, tall oil pitches and other fatty acids. For optimum performance the DLC should be allowed to rest twenty-four hours after blending before use. The DLC will coagulate during the twenty-four hour rest, but is easily friable. The percentage of tall oil component of the DLC affects the softening of the rubber particle. The greater the tall oil content, the softer the rubber particle. This is important in the engineering of rubber plastic composites using the DLC affecting such properties as shore hardness and flex modulus.

For best results thermally activated reactions the DLC should have a minimum moisture content of not more than 1% and preferably 0.05% because water will expand during thermal processing. This expansion of moisture can interfere with performance characteristics of the DLC.

It is well known in the prior art that adding vulcanized crumb rubber, with its high coefficient of friction, with for example, polyolefins, results in a slower production cycle, increased injection pressures, and has poor qualities of dispersion. Also it is well known in the prior art that the creation of thermoplastic olefins (“TPO”) and thermoplastic elastomers (“TPE”) compounds from virgin rubber requires both mastication and intensive mixing. The DLC of the preferred embodiment exhibits the unexpected and unanticipated characteristic of a substantially reduced coefficient of friction in a plastic production machine or plastic compounding extruder. This reduced coefficient of friction allows the DLC to be employed not only as a viscoelastic modifier with asphalt and various thermoplastics, such as, but not limited to polyolefins, acrylonitrile butadiene styrene (“ABS”), Nylon and polyethylene terephthalate (“PET”) but also surprisingly as a processing aid and carrying agent. In practice the DLC may be employed either (i) a dry liquid blend directly fed to, for example, a plastic injection mold machine or a plastic sheet extruder or (ii) in compound form. The DLC may also be formed into compounds with various plastics by using a traditional thermoplastic compounding extruder.

To employ the DLC as a carrying agent or processing aid, the preferred method is to combine Tall Oil Agents with various additives/modifiers, such as but not limited to, antifogging agents, coupling agents, antistatic agents, odorants, deodorants, colorants, antioxidants, fire retardants, and plasticizers, examples of such additives and their function being:

1. Specific fatty acid esters for antifogging characteristic, changing the DLC from hygroscopic to hydrophobic;

2. Coupling agents such as Silanes and Titanates to further enhance the bonding properties of the DLC with parent plastics;

3. Hindered Phenolics such as Butylated Hydroxytoluene (BHT) and thiobisphenolics to enhance antioxidation. Other useful antioxidants include aromatic amines and thioesters;

4. Antistatic agents such as neoalkoxy titanates and zirconates which are effective with polyolefins. Other useful antistatic agents include ethoxylated amines both natural and synthetic;

5. Organometallics employed as deodorants in the DLC. Odorants such as concentrated essence of leather or grass. Lemon, wood and cinnamon as well as other natural or synthetic odorants;

6. Fire retardants such as Alumina Trihydrates (ATH), borates and bromines;

7. Common plasticizers for use with PVC include di (2 ethylhexyl) phthalate (DOP) and diisooctyl phthalate (DIOP); and

8. Two basic types of colorants employed with the DLC, pigments and dyes. Dyes are comprised of organic compounds, primarily pyrazolones, quinophthalones, phthaloperinones and quinolines. Organic pigments include Carbon Black, AZO pigments, dioxazine pigments, isoindolinone pigments, phthalocyanine pigments, and quinacridone pigments.

The preferred method to combine additives/modifiers with the Tall Oil Agents is prior to blending with the crumb rubber. This is best accomplished by preheating the Tall Oil Agents to a temperature ranging from 50° C. to 150° C. and blending in from 5%-50% by weight percent of the desired additive(s) or modifier(s). Additive(s) or modifier(s) may be employed singly or in combination. For example a common antifogging agent such as, specific fatty acid esters, may be added at a rate of 10%, by weight, of the rate of the Tall Oil Agents, as well as a dry or liquid pigment concentrate at a rate of 30%, by weight, of the rate of the Tall Oil Agents.

All additions of additives or modifiers are based on the percent of weight of the Tall Oil Agent employed in making the DLC.

Thermoplastics useful in this invention are in the families of polyolefins including grades of polypropylene and polyethylene, ABS, Nylon, PET, polystyrene, polyester, recycled thermoplastic, polyacrylics and polyvinyl chloride (“PVC”).

The preferred embodiment may be employed in any of three methods:

1. As a dry blend with the DLC and thermoplastic mixtures fed directly to the plastics extruder or injection mold machine. The DLC may be used at rates by weight of from 10%-80% of the final blend with the parent thermoplastic.

2. As a specific compound wherein the DLC is thermo compounded by standard thermoplastic compounding machinery with a parent thermoplastic. The DLC may be used at rates by weight of from 10% to 80% with the parent thermoplastic.

3. As a dispersion pellet concentrate, where the DLC is compounded with a parent thermoplastic at, by weight rates, of up to 90%. The pellet concentrate may include pigments, antifogging agents, antistatic and or other additives appropriate to specific applications. In this form, a pellet, the preferred embodiments are more easily used in standard thermoplastics machinery than as a bulk solid powder.

Additives and modifiers for methods 1 and 2 may be added, preferably by first adding to the Tall Oil Agents and then adding the mixture to the rubber.

In all applications the DLC functions as an active filler creating composite materials that process as thermoplastic, but introduce physical properties exhibited in vulcanized rubber. These properties include, but are not limited to, impact modification, viscoelastic modification, sound deadening, vibration dampening, exceptional dispersion of rubber crumb, UV stabilization and excellent cold temperature and high temperature stability. These formulations save substantial energy over other methods to incorporate rubber into thermoplastic with other additives, since it does not require mastication, does not require thermo compounding, speeds process cycles and, uncharacteristically of rubber, does not increase injection pressure from normal plastic operation even at high, by weight, rates (at or below 50%) of use.

### Application

1. Two DLCs were prepared using ambient grind crumb rubber 100% passing 35 mesh and cryogenic crumb rubber 100% passing 24 mesh and 10% (by weight of the final DLC weight) DP5. A third DLC was prepared adding 10% blue powdered pigment and 10% yellow powdered pigment to DP5 which was 10% of the DLC weight without the additives, prior to mixing with the crumb rubber. Pigment weight percentages were calculated based on the original weight of the Tall Oil Agents. All samples were tested for moisture and found to have a moisture content less than 0.3%.

The two non pigmented DLCs were then dry blended with virgin copolymer polypropylene pellets, recycled HDPE multicolored flake, ABS pellets and virgin HDPE pellets. The DLCs were blended with each of the plastics at the following weight percentages: 25%, 40%, 50%, 60% and 70% of the total mixture weight.

The various blends were then shot to part on standard injection mold machines ranging from 300-900 tons. Processing settings were not changed on the injection mold machinery from the normal settings for 100% thermoplastic of the types mentioned above. Thin wall (soap dish), medium wall (speaker cone) and thick wall (pool filter base) were produced with the various mixtures. Part flexibility increased with increased percentage of rubber crumb. Cycle time was identical to non rubberized plastics of the types mentioned above. Individual part weights were within 3% of each other at each given level of DLC loading.

The pigmented sample of the DLC was dry blended at a 40% by weight rate of the total weight rate with the virgin HDPE. The resulting blend was shot into a thin wall part (soap dish) and an even forest green color was produced even though no blending was done below the pellet level of HDPE except as the rough blend was shot.

In all above mentioned applications individual part weights were within 3% of each other for each of the various loading levels of the DLC which is not experienced in the prior art in a dry blend form of crumb rubber. Processing adjustments to the molding were found to be unnecessary. All settings were calculated based on the parent plastic's optimum performance with the rubber content totally ignored.

2. Two DLCs were prepared using ambient grind crumb rubber 100% passing 35 mesh and cryogenic crumb rubber 100% passing 24 mesh and 10% (by weight of the final DLC weight) DP5. Samples were tested for moisture and found to have a moisture content less than 0.2%. The DLCs were then dry blended with virgin high impact, talc filled, virgin polypropylene at the following by weight rates: 30%, 40%, 50%, 60% and 70% of the total mixture rate.

The various blends were injection molded in a 90 ton machine. The mold was a single sprew with six cavities. The virgin polypropylene had an injection pressure of 354 psi. DLC loaded mixtures at by weight rates up to 50% had a drop in injection pressure to 305 psi. The molding cycle of DLC loaded mixtures at by weight rates of 60% and 70% were decreased by 20% and injection pressure increased, due to increased hydrodynamic pressure, to 405 psi. There were no short shots and relative part weights at the various loading levels were within 2%. Increasing part shot speed lead to smother surface texture. It was also apparent that higher loading of the DLC resulted in increased flexibility.

3. Two DLCs were prepared using ambient grind 100% passing 35 mesh crumb rubber and cryogenic 100% passing 24 mesh crumb rubber and 10% (by weight of the final DLC weight) DP5. Samples were tested for moisture and found to have a moisture content less than 0.2%. The DLCs were then dry blended with high impact, talc filled, virgin polypropylene at 30% by weight of the total mixture rate.

The resulting blend was injection molded on a 650 ton, twin hot runner, dual cavity mold. Approximately 30 parts of each blend were produced. Flexibility increased in the parts. Injection pressures were constant to that of the virgin polypropylene. Two parts, one ambient crumb rubber and one cryogenic crumb rubber, were weighed. The result in one sample was astonishing 0.01 gram difference for a part weighing 2.87 pounds when the difference was usually 3% in a dry blend form of crumb rubber.

4. Two DLCs were prepared using ambient grind 100% passing 35 mesh crumb rubber and cryogenic 100% passing 24 mesh crumb rubber and 10% (by weight of the final DLC weight) DP5. Samples were tested for moisture and found to have a moisture content less than 0.2%. The DLCs were then dry blended with high impact virgin polypropylene at 30%, 40% and 50% by weight of the total mixture weight.

The resulting blends were injection molded into laboratory plats on a 35 ton injection mold machine. Initial processing settings were set for the virgin polypropylene. Cycle time was initially set at 30 seconds. The cycle was decreased to the molding machine maximum of 21 seconds. The resulting decrease in cycle time is calculated at 30%. Flex modulus improved as well as increase in cold temperature impact in all samples because of the rubber additive uniformly dispersed with the plastic. Cycle time decrease yields energy savings as well.

5. A DLC was prepared using ambient grind crumb rubber, 100% passing 35 mesh and 10% (by weight of the final DLC weight) DP5. Samples were tested for moisture and found to have a moisture content less than 0.2%. The DLC was then dry blended with a high impact virgin polypropylene at 30% by weight of the total mixture weight.

The resulting dry blend was hand poured into a 3,500 ton 4 hot runner injection mold machine. The resulting parts, automotive fender shields were processed at an extremely fast 7.2 second fill. The rubberized fender shield demonstrated increased cold temperature impact over the virgin polypropylene. Another surprising result was when a five part weight comparison was done with the virgin polypropylene parts and the rubberized parts, the virgin polypropylene had a 4.3% weight variance among the parts, but the dry blend rubberized parts had a 3.1% weight variance.

Accordingly, because many varying and different embodiments maybe made with the scope of inventive concept herein taught including equivalent structures or materials hereafter thought of, and because many modifications may be made in the embodiments herein detailed in accordance with the descriptive requirements of the law, it is to be understood that the details herein are to be interpreted as illustrative and not in a limiting sense.

What is claimed as invention is:

1-23. (canceled)

24. A process for modifying a non-rubber compound selected from the group consisting of plastics, thermoplastics, thermoplastic elastomers, polyvinyl chloride, polyacrylics, polyurethanes, asphalt, epoxy and emulsions thereof, including latex comprising the steps of:
(1) combining a non-rubber compound with a dry liquid concentrate mixture to form a dry blend wherein the dry liquid concentrate mixture comprises:
a. substantially dry crumb rubber; and
b. a liquid agent selected from the group consisting of tall oil, tall oil heads, tall oil pitches, residue of tall oil production and other fatty acids;
(2) feeding said dry blend directly into a plastic production machine.

25. The process of claim 24, wherein said dry liquid concentrate further comprises at least one additive/modifier selected from the group consisting of antifogging agents, coupling agents, antistatic agents, odorants, deodorants, colorants, antioxidants, fire retardants, and placticizers.

26. The process of claim 25, wherein said additive/modifier are first added to said liquid agent to form an additive/modifier liquid agent mixture and then adding said additive/modifier liquid agent mixture to said substantially dry crumb rubber.

27. The process of claim 24, wherein the modification imparts elastomeric properties to said modified non-rubber compound.

28. The process of claim 24, wherein said elastomeric properties include impact modification, viscoelastic modification, sound deadening, vibration dampering, UV stabilization, cold temperature stability and high temperature stability.

29. The process of claim 24, wherein the dry blend is a bulk solid powder.

30. The process of claim 29, wherein the dry liquid concentrate comprises in a range about 10% to 80% by weight of said dry blend.

31. The process of claim 24, wherein the dry blend is a pellet concentrate.

32. The process of claim 31, wherein the dry liquid concentrate comprises up to 90% by weight of said dry blend.

33. The process of claim 24, wherein the plastic production machine is selected from the group of plastics extruder or injection mold machine.

34. A process for modifying a non-rubber compound selected from the group consisting of plastics, thermoplastics, thermoplastic elastomers, polyvinyl chloride, polyacrylics, polyurethanes, epoxy and emulsions thereof, including latex to form a composite material comprising the steps of:
(1) preparing a dry blend by combining a dry liquid concentrate mixture with the non-rubber compound wherein the dry liquid concentrate mixture comprises:
a. substantially dry crumb rubber; and
b. a liquid agent selected from the group consisting of tall oil, tall oil heads, tall oil pitches, residue of tall oil production and other fatty acids;
(2) thermo compounding said dry blend with a thermo plastic compounding machine.

35. The process of claim 34, wherein said dry liquid concentrate comprises in a range about 10% to 80% by weight of said dry blend.

36. The process of claim 34, wherein said dry liquid concentrate further comprises an additives/modifiers selected from the group consisting of antifogging agents, coupling agents, antistatic agents, odorants, deodorants, colorants, antioxidants, fire retardants, and placticizers.

37. The process of claim 36, wherein said additives/modifiers are first added to said liquid agent to form an additive/modifier liquid agent mixture and then adding said additive/modifier liquid agent mixture to said substantially dry crumb rubber.

38. The process of claim 34, wherein the modification imparts elastomeric properties to said composite material.

39. The process of claim 34, wherein said elastomeric properties include impact modification, viscoelastic modification, sound deadening, vibration dampering, UV stabilization, cold temperature stability and high temperature stability.

40. A composite material resulting from claim 34.

41. A process for producing a final product made from a modified non-rubber compound comprising the steps of:
(1) combining a non-rubber compound selected from the group consisting of plastics, thermoplastics, thermoplastic elastomers, polyvinyl chloride, polyacrylics, polyurethanes, epoxy and emulsions thereof with a dry liquid concentrate mixture to form a dry blend wherein the dry liquid concentrate mixture comprises:
a. substantially dry crumb rubber; and
b. a liquid agent selected from the group consisting of tall oil, tall oil heads, tall oil pitches, residue of tall oil production and other fatty acids;
(2) feeding said dry blend directly into a plastic production machine to produce a modified non-rubber final product.

42. The process of claim 41, wherein said dry liquid concentrate further comprises additives/modifiers selected from the group consisting of antifogging agents, coupling agents, antistatic agents, odorants, deodorants, colorants, antioxidants, fire retardants, and placticizers.

43. The process of claim 42, wherein said additives/modifiers are first added to said liquid agent to form an additive/modifier liquid agent mixture and then adding said additive/modifier liquid agent mixture to said substantially dry crumb rubber.

44. The process of claim 41, wherein said modified non-rubber final product has elastomeric properties.

45. The process of claim 44, wherein said elastomeric properties include impact modification, viscoelastic modification, sound deadening, vibration dampering, UV stabilization, cold temperature stability and high temperature stability.

46. The process of claim 41, wherein the dry blend is a bulk solid powder.

47. The process of claim 46, wherein the dry liquid concentrate comprises in a range about 10% to 80% by weight of said composite material.

48. The process of claim 41, wherein the dry blend is a pellet concentrate.

49. The process of claim 48, wherein the dry liquid concentrate comprises up to 90% by weight of said dry blend.

50. The process of claim 41, wherein the plastic production machine is selected from the group of plastics extruder or injection mold machine.

51. The final product resulting from claim 41.
